(19) United States
(12) Patent Application Publication
(10) Pub. No.: US 2026/0323671 A1
(43) Pub. Date: Oct. 15, 2026

(54) INTER DEVICE COORDINATION FOR UNLICENSED OPERATION

(71) Applicant: QUALCOMM INCORPORATED, San Diego, CA (US)

(72) Inventors: Anantharaman Balasubramanian, San Diego, CA (US); Shuanshuan Wu, San Diego, CA (US); Stelios Stefanatos, San Diego, CA (US)

(21) Appl. No.: 19/101,232

(22) PCT Filed: Sep. 14, 2023
(86) PCT No.: PCT/US2023/074236

§ 371 Date: Feb. 4, 2025

(30) Foreign Application Priority Data
Oct. 7, 2022 (GR) 20220100823

(51) Int. Cl. H04W 72/40

(52) U.S. Cl. CPC H04W 72/40

(57) ABSTRACT

Methods, systems, and devices for wireless communication are described. A first user equipment (UE) may perform a resource sensing procedure to identify a set of resources of a shared radio frequency spectrum band that may be reserved for wireless communications associated with a first radio access technology (RAT). The first UE may be capable of supporting both the first RAT and a second RAT. The first UE may transmit, to a second UE that may be capable of supporting the second RAT, an inter-UE coordination message. The inter-UE coordination message may be based at on the resource sensing procedure. The inter-UE coordination message may indicate a duration during which the second UE may avoid transmitting using the shared radio frequency spectrum band. The duration may be based on the identified set of resources.

### CROSS REFERENCES

The present Application is a 371 national stage filing of International PCT Application No. PCT/US2023/074236 by Balasubramanian et al. entitled “INTER DEVICE COORDINATION FOR UNLICENSED OPERATION,” filed Sep. 14, 2023; and claims priority to Greek Patent Application No. 20220100823 by Balasubramanian et al. entitled “INTER DEVICE COORDINATION FOR UNLICENSED OPERATION,” filed Oct. 7, 2022, each of which is assigned to the assignee hereof, and each of which is expressly incorporated by reference in its entirety herein.

### FIELD OF TECHNOLOGY

The following relates to wireless communication, including inter device coordination for unlicensed operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless communications systems may support wireless communication using a shared radio frequency spectrum band.

### SUMMARY

The described techniques relate to improved methods, systems, devices, and apparatuses that support inter device coordination for unlicensed operation. For example, the described techniques provide a framework for coordination between user equipment (UE) capable of supporting multiple radio access technologies (RATs). In some examples, a first UE may perform a resource sensing procedure to identify a set of resources of a shared radio frequency spectrum band (e.g., an unlicensed band) that may be reserved for wireless communications associated with a first RAT. The first UE may be capable of supporting both the first RAT and a second RAT. For example, the first UE may transmit, to a second UE that may be capable of supporting the second RAT, an inter-UE coordination message. The inter-UE coordination message may be based on the resource sensing procedure. For example, the inter-UE coordination message may indicate a duration during which the second UE may avoid transmitting using the shared radio frequency spectrum band. In some examples, the duration may be based on the identified set of resources.

A method for wireless communication at a first UE is described. The method may include performing, at the first UE, a resource sensing procedure to identify a set of resources of a shared radio frequency spectrum band that is reserved for wireless communications associated with a first RAT, the first UE capable of supporting both the first RAT and a second RAT and transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

An apparatus for wireless communication at a first UE is described. The apparatus may include a processor, memory coupled with the processor, and instructions stored in the memory. The instructions may be executable by the processor to cause the apparatus to perform, at the first UE, a resource sensing procedure to identify a set of resources of a shared radio frequency spectrum band that is reserved for wireless communications associated with a first RAT, the first UE capable of supporting both the first RAT and a second RAT and transmit, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

Another apparatus for wireless communication at a first UE is described. The apparatus may include means for performing, at the first UE, a resource sensing procedure to identify a set of resources of a shared radio frequency spectrum band that is reserved for wireless communications associated with a first RAT, the first UE capable of supporting both the first RAT and a second RAT and means for transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

A non-transitory computer-readable medium storing code for wireless communication at a first UE is described. The code may include instructions executable by a processor to perform, at the first UE, a resource sensing procedure to identify a set of resources of a shared radio frequency spectrum band that is reserved for wireless communications associated with a first RAT, the first UE capable of supporting both the first RAT and a second RAT and transmit, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

Some examples of the method, apparatuses, and non-transitory computer-readable medium described herein may further include operations, features, means, or instructions for receiving, from a third UE capable of supporting the first RAT, a message indicating at least one resource that may be reserved for wireless communications associated with the first RAT, where the set of resources may be identified based on the message.

In some examples of the method, apparatuses, and non-transitory computer-readable medium described herein, transmitting the inter-UE coordination message may include operations, features, means, or instructions for transmitting, to the second UE, the inter-UE coordination message indicating the duration and a start time associated with the duration.

In some examples of the method, apparatuses, and non-transitory computer-readable medium described herein, transmitting the inter-UE coordination message may include operations, features, means, or instructions for transmitting, to the second UE, the inter-UE coordination message indicating a quantity of interframe spaces during which the second UE may be to avoid transmitting using the shared radio frequency spectrum band.

In some examples of the method, apparatuses, and non-transitory computer-readable medium described herein, transmitting the inter-UE coordination message may include operations, features, means, or instructions for transmitting, to the second UE, the inter-UE coordination message including a duration field that indicates a transmission duration during which a communication channel of the shared radio frequency spectrum band may be occupied, the transmission duration including the duration.

In some examples of the method, apparatuses, and non-transitory computer-readable medium described herein, transmitting the inter-UE coordination message may include operations, features, means, or instructions for transmitting, to the second UE, the inter-UE coordination message indicating the duration and a communication channel of the shared radio frequency spectrum band that the second UE may be to use or may be to avoid transmitting using for wireless communications associated with the second RAT.

In some examples of the method, apparatuses, and non-transitory computer-readable medium described herein, transmitting the inter-UE coordination message may include operations, features, means, or instructions for transmitting, to the second UE, the inter-UE coordination message indicating the duration during a transmission gap.

In some examples of the method, apparatuses, and non-transitory computer-readable medium described herein, the transmission gap corresponds to a time interval of a set of multiple time intervals that occur periodically or aperiodically.

In some examples of the method, apparatuses, and non-transitory computer-readable medium described herein, transmitting the inter-UE coordination message may include operations, features, means, or instructions for transmitting, to the second UE, the inter-UE coordination message indicating the duration in response to identifying that an event trigger may be satisfied.

In some examples of the method, apparatuses, and non-transitory computer-readable medium described herein, transmitting the inter-UE coordination message may include operations, features, means, or instructions for transmitting, to the second UE, the inter-UE coordination message indicating the duration in response to a quantity of UEs located in an environment associated with the first UE satisfying a threshold.

In some examples of the method, apparatuses, and non-transitory computer-readable medium described herein, transmitting the inter-UE coordination message may include operations, features, means, or instructions for receiving, from the second UE, a message indicating a request for assistance information from the first UE and transmitting, to the second UE, the inter-UE coordination message indicating the duration in response to receiving the request.

In some examples of the method, apparatuses, and non-transitory computer-readable medium described herein, receiving the request may include operations, features, means, or instructions for receiving, from the second UE, the message indicating the request for assistance information corresponding to a second duration, where the resource sensing procedure may be performed in response to the indicated request, and where the set of resources occur during the second duration.

In some examples of the method, apparatuses, and non-transitory computer-readable medium described herein, performing the resource sensing procedure may include operations, features, means, or instructions for performing, at the first UE, the resource sensing procedure to identify the set of resources of the shared radio frequency spectrum band that may be reserved for wireless communications associated with the first RAT, where the first RAT may be based on one or more of an identifier associated with the first UE, an identifier associated with the second UE, and an identifier associated with a service provider for the first UE.

In some examples of the method, apparatuses, and non-transitory computer-readable medium described herein, performing the resource sensing procedure may include operations, features, means, or instructions for performing, at the first UE, the resource sensing procedure to identify the set of resources of the shared radio frequency spectrum band that may be reserved for wireless communications associated with the first RAT, where the first RAT may be based on a ratio between a first duration during which the first UE may be to perform a first type of wireless communications and a second duration during which the first UE may be to perform a second type of wireless communications.

In some examples of the method, apparatuses, and non-transitory computer-readable medium described herein, the first RAT may be based on the ratio between the first duration and the second duration being satisfied during a time window.

In some examples of the method, apparatuses, and non-transitory computer-readable medium described herein, performing the resource sensing procedure may include operations, features, means, or instructions for performing, at the first UE during a first duration, the resource sensing procedure to identify the set of resources of the shared radio frequency spectrum band that may be reserved for wireless communications associated with the first RAT, where the first RAT corresponds to a first type of wireless communications based on the first UE performing a second type of wireless communications during a second duration prior to the first duration.

In some examples of the method, apparatuses, and non-transitory computer-readable medium described herein, performing the resource sensing procedure may include operations, features, means, or instructions for performing, at the first UE, the resource sensing procedure to identify a first set of resources of the shared radio frequency spectrum band that may be reserved for wireless communications associated with the first RAT and performing, at the first UE, a partial resource sensing procedure to identify a second set of resources of the shared radio frequency spectrum band that may be reserved for wireless communications associated with the second RAT, where the duration may be based on the identified first set of resources and the identified second set of resources.

A method for wireless communication at a first UE is described. The method may include receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT and refraining from transmitting using resources of the shared radio frequency spectrum band during the duration in response to receiving the inter-UE coordination message.

An apparatus for wireless communication at a first UE is described. The apparatus may include a processor, memory coupled with the processor, and instructions stored in the memory. The instructions may be executable by the processor to cause the apparatus to receive, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT and refrain from transmitting using resources of the shared radio frequency spectrum band during the duration in response to receiving the inter-UE coordination message.

Another apparatus for wireless communication at a first UE is described. The apparatus may include means for receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT and means for refraining from transmitting using resources of the shared radio frequency spectrum band during the duration in response to receiving the inter-UE coordination message.

A non-transitory computer-readable medium storing code for wireless communication at a first UE is described. The code may include instructions executable by a processor to receive, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT and refrain from transmitting using resources of the shared radio frequency spectrum band during the duration in response to receiving the inter-UE coordination message.

In some examples of the method, apparatuses, and non-transitory computer-readable medium described herein, receiving the inter-UE coordination message may include operations, features, means, or instructions for receiving, from the second UE, the inter-UE coordination message indicating the duration that may be based on the set of resources, where the set of resources may be identified at the second UE based on a resource sensing procedure performed at the second UE.

In some examples of the method, apparatuses, and non-transitory computer-readable medium described herein, the duration may be based on a second set of resources that may be reserved for wireless communications associated with the second RAT and the second set of resources may be identified at the second UE based on a partial sensing procedure performed at the second UE.

In some examples of the method, apparatuses, and non-transitory computer-readable medium described herein, receiving the inter-UE coordination message may include operations, features, means, or instructions for receiving, from the second UE, the inter-UE coordination message indicating the duration and a start time associated with the duration.

In some examples of the method, apparatuses, and non-transitory computer-readable medium described herein, receiving the inter-UE coordination message may include operations, features, means, or instructions for receiving, from the second UE, the inter-UE coordination message indicating a quantity of interframe spaces during which the first UE may be to avoid transmitting using the shared radio frequency spectrum band.

In some examples of the method, apparatuses, and non-transitory computer-readable medium described herein, receiving the inter-UE coordination message may include operations, features, means, or instructions for receiving, from the second UE, the inter-UE coordination message including a duration field that indicates a transmission duration during which a communication channel of the shared radio frequency spectrum band may be occupied, the transmission duration including the duration.

In some examples of the method, apparatuses, and non-transitory computer-readable medium described herein, receiving the inter-UE coordination message may include operations, features, means, or instructions for receiving, from the second UE, the inter-UE coordination message indicating the duration and a communication channel of the shared radio frequency spectrum band that the first UE may be to use or may be to avoid transmitting using for wireless communications associated with the second RAT.

In some examples of the method, apparatuses, and non-transitory computer-readable medium described herein, receiving the inter-UE coordination message may include operations, features, means, or instructions for receiving, from the second UE, the inter-UE coordination message indicating the duration during a transmission gap.

In some examples of the method, apparatuses, and non-transitory computer-readable medium described herein, receiving the inter-UE coordination message may include operations, features, means, or instructions for receiving, from the second UE, the inter-UE coordination message indicating the duration based on an event trigger being satisfied or a quantity of UEs located in an environment associated with the second UE satisfying a threshold.

In some examples of the method, apparatuses, and non-transitory computer-readable medium described herein, receiving the inter-UE coordination message may include operations, features, means, or instructions for transmitting, to the second UE, a message indicating a request for assistance information from the second UE and receiving, from the second UE, the inter-UE coordination message indicating the duration in response to transmitting the request.

### BRIEF DESCRIPTION OF THE DRAWINGS

FIGS. 1 and 2 each illustrate an example of a wireless communications system that supports inter device coordination for unlicensed operation in accordance with one or more aspects of the present disclosure.

FIG. 3 illustrates an example of a timing diagram that supports inter device coordination for unlicensed operation in accordance with one or more aspects of the present disclosure.

FIG. 4 illustrates an example of a process flow that supports inter device coordination for unlicensed operation in accordance with one or more aspects of the present disclosure.

FIGS. 5 and 6 show block diagrams of devices that support inter device coordination for unlicensed operation in accordance with one or more aspects of the present disclosure.

FIG. 7 shows a block diagram of a communications manager that supports inter device coordination for unlicensed operation in accordance with one or more aspects of the present disclosure.

FIG. 8 shows a diagram of a system including a device that supports inter device coordination for unlicensed operation in accordance with one or more aspects of the present disclosure.

FIGS. 9 through 12 show flowcharts illustrating methods that support inter device coordination for unlicensed operation in accordance with one or more aspects of the present disclosure.

### DETAILED DESCRIPTION

Some wireless communications systems may include communication devices, such as user equipments (UEs) or network entities, that support wireless communications using one or more radio access technologies (RATs). For example, the communication devices may support wireless communications using one or multiple cellular RATs, such as fourth generation (4G) systems (e.g., Long Term Evolution (LTE) systems), and fifth generation (5G) systems (e.g., New Radio (NR) systems), among other subsequent generations of cellular RATs. In some examples, such wireless communications systems may support sidelink communications (e.g., using one or more cellular RATs) using a shared radio frequency spectrum band (e.g., an unlicensed radio frequency spectrum band, an unlicensed band) that may be shared between one or more other RATs, such as Wi-Fi or Bluetooth, among other examples. In such examples, prior to using the shared radio frequency spectrum band for a transmission, some communication devices that support a same RAT (e.g., a cellular RAT, Wi-Fi) may communicate regarding resources of the shared radio frequency spectrum band that may be available (or unavailable) for communications using the RAT. For example, devices that support a cellular RAT (e.g., cellular devices) may receive and decode sidelink control information (SCI) to identify resources of the shared radio frequency spectrum band that may be reserved for cellular communications (e.g., sidelink communications). Additionally, or alternatively, devices that support Wi-Fi (e.g., Wi-Fi devices) may receive and decode frames to identify durations during which the shared radio frequency spectrum band (e.g., a wireless medium) may be reserved for Wi-Fi communications.

In some examples, however, communication devices capable of supporting a single type of RAT (e.g., a cellular RAT or Wi-Fi) may be incapable of decoding messages transmitted using another type of RAT. For example, cellular devices may be incapable of decoding Wi-Fi messages and Wi-Fi devices may be incapable of decoding cellular messages. In such an example, the cellular devices may be unaware of resources reserved for Wi-Fi communications and, similarly, the Wi Fi devices may be unaware of resource reserved for cellular communications. In some examples, an inability of some communication devices communicate regarding resources of the shared radio frequency spectrum band that may be available (or unavailable) may lead to reduced resource utilization within some wireless communications systems.

Various aspects of the present disclosure generally relate to techniques for inter device coordination for unlicensed operation, and more specifically, to a framework for coordination between UEs that support multiple RATs. For example, a first UE may be capable of supporting multiple RATs, such as a cellular RAT and Wi Fi. In such an example, the first UE may serve as an intermediary UE and perform inter-UE coordination between cellular devices (e.g., cellular UEs) and Wi-Fi devices (e.g., Wi-Fi UEs). In some examples, the first UE may transmit an inter-UE coordination message to a second UE (e.g., a cellular UE or a Wi-Fi UE) that may indicate a duration during which the second UE may avoid transmitting using the shared radio frequency spectrum band. In such examples, the duration may be based on one or multiple resource sensing procedures performed at the first UE, for example to identify resources reserved for Wi-Fi communications or cellular communications, or both.

In some examples, the first UE may transmit the inter-UE coordination message to the second UE during a duration that may occur periodically or aperiodically. Additionally, or alternatively, the first UE may transmit the inter-UE coordination message in response to a request (e.g., from the second UE) or an event trigger being satisfied. For example, the first UE may transmit the inter-UE coordination message to the second UE based on a quantity of UEs located in a same geographic area as the first UE (or the second UE) satisfying a threshold. In some examples, the first UE may operate as a Wi-Fi UE and, for example, perform a Wi-Fi resource sensing procedure. In such an example, the first UE may transmit the inter-UE coordination message to a cellular UE. Additionally, or alternatively, the first UE may operate as a cellular UE and, for example, perform a cellular resource sensing procedure. In such an example, the first UE may transmit the inter-UE coordination message to a Wi-Fi UE. In some examples, the first UE may determine whether to operate as a cellular UE or a Wi-Fi UE based on a ratio between a duration during which the first UE may operate as cellular UE and another duration during which the first UE may operates as a Wi-Fi UE. Additionally, or alternatively, the first UE may determine whether to operate as a Wi-Fi UE or a cellular UE based on one or more identifiers associated with the first UE or the second UE, such as a transmitter identifier, a destination identifier, or a provider service identifier, among other possible examples. In some examples, transmitting the inter-UE coordination message to other UEs capable of supporting a single RAT may increase resource utilization with a wireless communications system, among other possible benefits.

Aspects of the disclosure are initially described in the context of wireless communications systems. Aspects of the disclosure are also described in the context of a timing diagram and a process flow. Aspects of the disclosure are further illustrated by and described with reference to apparatus diagrams, system diagrams, and flowcharts that relate to inter device coordination for unlicensed operation.

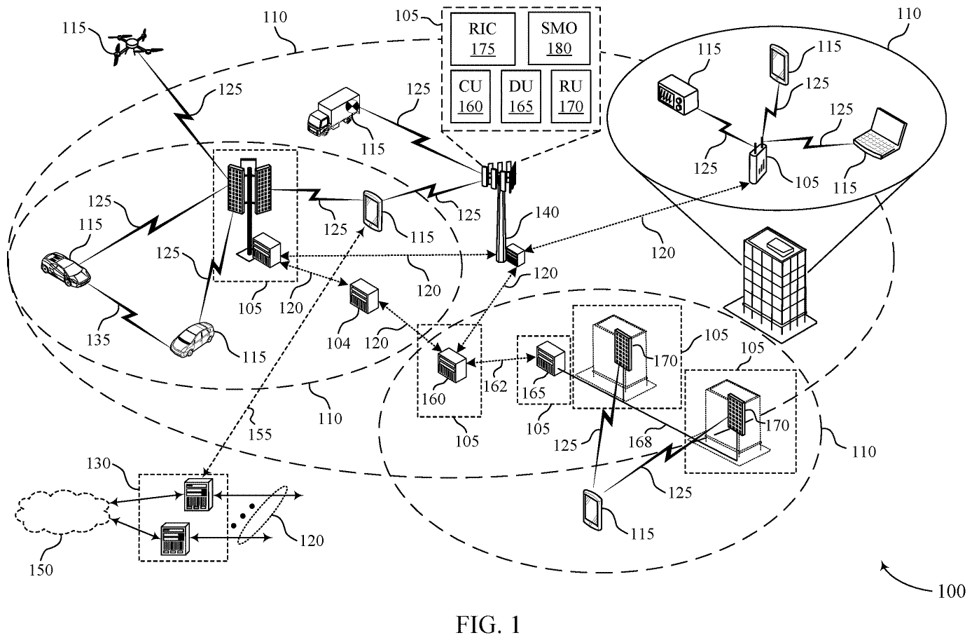

FIG. 1 illustrates an example of a wireless communications system 100 that supports inter device coordination for unlicensed operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, radio frequency functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1,F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support inter device coordination for unlicensed operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of a radio frequency spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed radio frequency spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may support a framework for coordination between UEs 115 that support multiple RATs. For example, a first UE 115 may perform a resource sensing procedure to identify a set of resources of a shared radio frequency spectrum band (e.g., unlicensed band, unlicensed spectrum, shared spectrum) that may be reserved for wireless communications associated with a first RAT. The first UE 115 may be capable of supporting both the first RAT and a second RAT. For example, the first UE 115 may transmit, to a second UE 115 that may be capable of supporting the second RAT, an inter-UE coordination message. The inter-UE coordination message may be based at on the resource sensing procedure. For example, the inter-UE coordination message may indicate a duration during which the second UE 115 may avoid transmitting using the shared radio frequency spectrum band. In some examples, the duration may be based on the identified set of resources. Indicating the duration during which the second UE 115 may avoid transmitting using the shared radio frequency spectrum band may, in some examples, enable increased resource utilization within the wireless communications system 100, among other possible benefits.

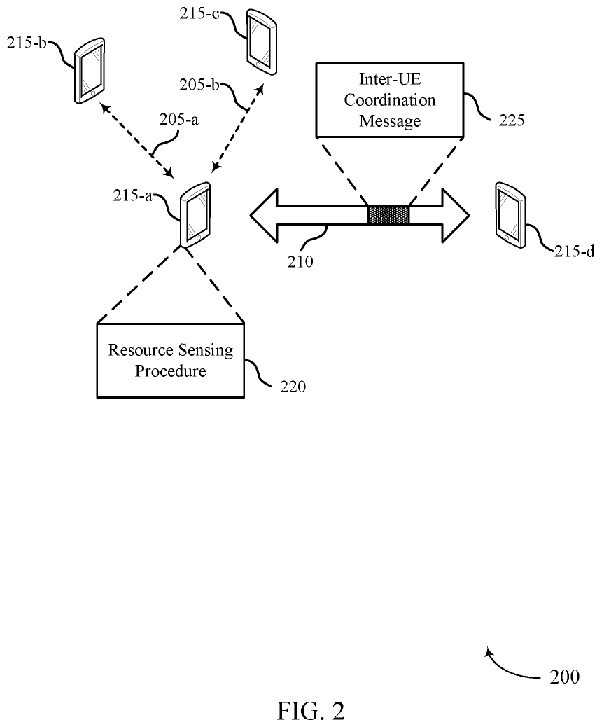

FIG. 2 illustrates an example of a wireless communications system 200 that supports inter device coordination for unlicensed operation in accordance with one or more aspects of the present disclosure. In some examples, the wireless communications system 200 may implement aspects of the wireless communications system 100. For example, the wireless communications system 200 may include a UE 215-a, a UE 215-b, a UE 215-c, and a UE 215-d, which may be examples a UE 115 as described with reference to FIG. 1. In the example of FIG. 2, the UE 215-a may be an example of an intermediary UE, which may support multiple RATs. For example, the UE 215-a may be capable of supporting one or more cellular RATs and Wi-Fi, among other examples of RATs.

In some examples, the wireless communications system 200 may support inter-UE coordination, such as to addresses reduced resource utilization due to a hidden node or half duplex communication. For example, the UE 215-a may provide, to the UE 215-b or the UE 215-c an indication of suitable resources that the UE 215-b or the UE 215-c may use for wireless communications associated with a first RAT. In some examples, of the wireless communications system 200, the first RAT may correspond to a cellular RAT. In such examples, the UE 215-a may communicate the indication of suitable resources to the UE 215-b and the UE 215-c using one or more first communication links 205 (e.g., a first communication link 205-a and a first communication link 205-b, respectively). In some examples, the first communication link 205-a and the first communication link 205-b may each be examples of a communication link 135 (e.g., a sidelink) as described with reference to FIG. 1.

In some examples, the UE 215-a may provide, to the UE 215-b or the UE 215-c, an indication of expected (or detected) collision resource conflicts, such as between two or more of the UE 215-a, the UE 215-b, and the UE 215-c. For example, the UE 215-a may transmit coordination information to the UE 215-b or the UE 215-c to improve resource utilization within the wireless communications system 200. In some examples, the UE 215-a may determine (e.g., and indicate to the UE 215-b or the UE 215-c) collisions that may occur between resources reserved at multiple UEs that support the cellular RAT based on reservation announcements. For example, the UE 215-a may provide, to the UE 215-b, an indication of collision resource conflicts with the UE 215-b based on receiving SCI transmitted from the UE 215-b. That is, the UE 215-a may use SCI received (e.g., and decoded) from the UE 215-b to detect collisions between resources reserved at the UE 215-b and one or more other UEs capable of supporting the cellular RAT. For example, the UE 215-a may determine (e.g., detect) collisions with resource reserved at the UE 215-b based on receiving and decoding SCI (e.g., a reservation announcement) transmitted from the UE 215-b and one or more other UEs that support the cellular RAT, such as the UE 215-c.

Additionally, or alternatively, the UE 215-a may transmit an indication of detected collisions to the UE 215-b, for example as coordination information. In such an example, the UE 215-b may consider sensing performed at the UE 215-b or the coordination information received from the UE 215-a, or both. In some examples, the UE 215-a may indicate the coordination information with other UEs (e.g., the UE 215-c). Additionally, or alternatively, while the example of FIG. 2 illustrates the UE 215-a as a single device, the UE 215-a may be an example of multiple devices (e.g., multiple UEs). For example, the UE 215-a may include one or more other UEs (e.g., at the lower layer). In such an example, the UE 215-b may receive the coordination information from one or more of the multiple UEs included in the UE 215-a. That is, the UE 215-b or the UE 215-b may receive coordination information from multiple UEs.

In some examples of the wireless communications system 200, the UE 215-a, the UE 215-b, and the UE 215-c may operate using one or more modes. For example, the UE 215-a, the UE 215-b, and the UE 215-c may operate using Mode-2 sidelink or may operate out-of-coverage (OoC). For example, the UE 215-a, the UE 215-b, and the UE 215-c may be OoC of a network entity that may serve the UE 215-a, the UE 215-b, and the UE 215-c. In such an example, the UE 215-a, the UE 215-b, and the UE 215-c may use the shared radio frequency spectrum band (e.g., an unlicensed band) for sidelink communications, which may be scheduled at (or between) the respective UEs. That is, sidelink communications at the UE 215-a using the shared radio frequency spectrum band may be scheduled at the UE 215-a. In some examples, the sidelink communications may be scheduled at the UE 215-a based on a channel sensing procedures (e.g., a resource sensing procedure, a channel access procedure) performed at the UE 215-a.

Additionally or alternatively, while some UEs may be capable of supporting multiple types of RATs (e.g., the UE 215-a), other UEs may be capable of supporting a single type of RAT (e.g., the UE 215-b, the UE 215-c, the UE 215-d). For example, while the UE 215-a may be capable of supporting a cellular RAT and Wi-Fi (e.g., may be a cellular and Wi-Fi UE), the UE 215-b and the UE 215-c may be capable of supporting the cellular RAT (e.g., may be cellular UEs) and the UE 215-d may be capable of supporting Wi-Fi (e.g., may be a Wi-Fi UE). In such examples, the cellular UEs (e.g., the UE 215-a, the UE 215-b, and the UE 215-c) may perform resource reservations. For example, a cellular UE may perform a resource reservation procedure that may be based on a mode of operation associated with the cellular UE, such as Mode-2 sidelink operations. In some examples, based on the resource reservation (e.g., a reservation announcement included in SCI) transmitted from the cellular UE, one or more other cellular UEs may refrain from transmitting in resources reserved by the cellular UE. In some examples, the resource reservation may be transmitted from the cellular UE as part of the resource reservation procedure. That is, a cellular UE may use resource reservations transmitted from other cellular UEs to determine one or more resources which the cellular UE may refrain from using for sidelink communications. For example, the UE 215-a and the UE 215-b may receive (and decode) SCI from the UE 215-c indicating one or more resources of the shared radio frequency spectrum that may be reserved at the UE 215-c for sidelink communications (e.g., cellular communications). In such an example, the UE 215-a and the UE 215-b may refrain from transmitting using the indicated resources. In some examples, while resource reservations may be understood (e.g., decoded) by the cellular UEs, Wi-Fi UEs may be incapable of decoding resource reservations transmitted as cellular messages. That is, while the resource reservations may be decoded by the UE 215-a, the UE 215-b, the UE 215-c, but the UE 215-d may be incapable of decoding the resource reservations. In such examples, the UE 215-d may be unaware of (e.g., incapable of identifying) resources reserved at the UE 215-c. That is, the UE 215-d may be incapable of detecting and resolving collisions with the UE 215-c.

Additionally or alternatively, the UE 215-d may transmit one or more messages, such as a request to send (RTS), a clear to send (CTS), or a network allocation vector (NAV), to indicate medium reservations to other Wi-Fi UEs (e.g., including the UE 215-a). In some examples, such messages may aid the UE 215-d in mitigating one or more hidden node problems. For example, the other Wi-Fi UEs may avoid transmitting using the medium (e.g., the shared radio frequency spectrum band) during some durations based on one or more of the messages received (and decoded) from the UE 215-d. In some examples, while messages transmitted from the UE 215-d may be understood (e.g., received and decoded) by other Wi-Fi UEs, such as the UE 215-a, some cellular UEs (e.g., the UE 215-b and the UE 215-c) may be incapable of decoding Wi-Fi messages. In such examples, the UE 215-b and the UE 215-c may be unaware of (e.g., incapable of identifying) resources reserved at the UE 215-d. That is, the UE 215-b and the UE 215-c may be incapable of detecting and resolving collisions with the UE 215-d. In some examples, an inability to detect a resolve collisions between UEs that support multiple (e.g., different) RATs may lead to reduced resource utilization of the shared radio frequency spectrum band.

In some examples, one or more techniques for inter device coordination for unlicensed operation, as described herein, may provide one or more enhancements to resource utilization for the shared radio frequency spectrum band (e.g., unlicensed operations). For example, the wireless communications system 200 may support a framework (e.g., signaling methods or procedures) for coordination between devices capable of supporting multiple RATs. As illustrated in the example of FIG. 2, the UE 215-a may serve as an intermediary UE to perform inter-UE coordination between one or more cellular UEs (e.g., the UE 215-b and the UE 215-c) and one or more Wi-Fi UEs (e.g., the UE 215-d). In some examples, although the UE 215-a may be a cellular and Wi-Fi UE, the UE 215-a may operate as a cellular UE (e.g., a sidelink UE) or a Wi-Fi UE. For example, the UE 215-a may operate as a cellular UE and obtain assistance information (e.g., coordination information) from other cellular UEs (e.g., the UE 215-b and the UE 215-c) based on a resource sensing procedure 220 (e.g., a channel sensing procedure). In such an example, the UE 215-a may transmit an inter-UE coordination message 225 to the UE 215-d as a Wi-Fi-message (e.g., an equivalent Wi-Fi message) using a second communication link 210 (e.g., a Wi-Fi link). That is, the UE 215-a may transmit the inter-UE coordination message 225 to the UE 215-d to indicate (e.g., relay) assistance information obtained at the UE 215-a from the UE 215-b and the UE 215-c. In some examples, the inter-UE coordination message 225 may indicate a duration during which the UE 215-d may avoid transmitting using the shared radio frequency spectrum band. For example, the UE 215-a may determine (e.g., calculate) a duration during which the UE 215-d may avoid transmitting using the shared radio frequency spectrum band based on the resource sensing procedure 220 and indicate the duration to the UE 215-d using the inter-UE coordination message 225.

Although the example of FIG. 2 illustrates the UE 215-a as a single device, the wireless communications system may support multiple intermediary UEs capable of supporting a cellular RAT and Wi-Fi. For example, the wireless communications system may support two intermediary UEs in which a first intermediary UE (e.g., a first cellular and Wi-Fi UE) may operate as a cellular UE and transmit assistance information messages (e.g., a default assistance message, a default coordination messages) to a cellular UE. Additionally, or alternatively, a second intermediary UE (e.g., a second cellular and Wi-Fi UE) may operate as a Wi-Fi UE and transmit a Wi-Fi medium reservation (e.g., channel reservation) to the cellular UE. In some examples, the second intermediary UE may transmit the Wi-Fi medium reservation to the cellular UE using the inter-UE coordination message 225. In such an example, the inter-UE coordination message 225 may be transmitted as a cellular message (e.g., an assistance information message, an equivalent sidelink assistance information message). In some examples, serving as an intermediary UE to perform inter-UE coordination between one or more cellular UEs (e.g., the UE 215-b and the UE 215-c) and one or more Wi-Fi UEs (e.g., the UE 215-d) may enable the UE 215-a to increase resource utilization within the wireless communications system 200, among other possible benefits.

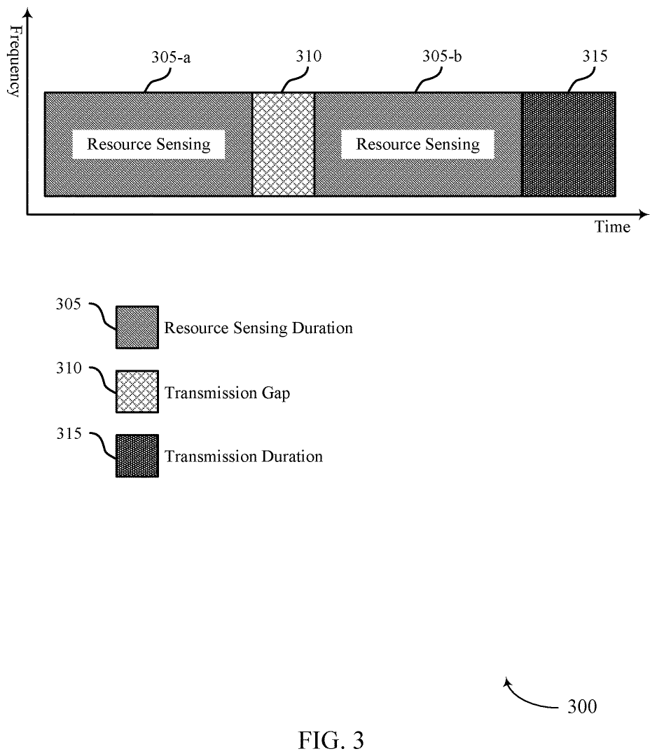

FIG. 3 illustrates an example of a timing diagram 300 that supports inter device coordination for unlicensed operation in accordance with one or more aspects of the present disclosure. In some examples, the timing diagram 300 may implement or be implemented at one or more aspects of the wireless communications systems 100 and the wireless communications system 200. For example, the timing diagrams 300 may be implemented at one or more UEs, which may be examples of the corresponding devices as described with reference to FIGS. 1 and 2.

For example, the timing diagram 300 may be implemented at a UE capable of supporting multiple RATs. The UE may be referred to as an intermediary UE. In some examples, the intermediary UE may be capable of supporting a cellular RAT and Wi-Fi. In such an example, a wireless communication network may enable the intermediary UE (or the intermediary UE may be otherwise enabled) to transmit inter-UE coordination signaling information (e.g., based on a cellular resource reservation map), to one or more other UEs that may be capable of supporting Wi-Fi. In some examples, the intermediary UE (e.g., a cellular and Wi-Fi UE) may obtain the cellular resource reservation map based on SCI decoded from other cellular UEs or a resource sensing procedure performed at the intermediary UE, or both.

In some examples, the intermediary UE may operate as a cellular UE and provide assistance information (e.g., an inter-UE coordination message transmitted as a Wi-Fi message) to a Wi-Fi UE. In some examples, the provided assistance information may be based on information associated with the resource reservation map. For example, the intermediary UE may transmit an inter-UE coordination message to the Wi-Fi UE. In some examples, the inter-UE coordination message may indicate a duration during which the Wi-Fi UE may avoid transmitting using the shared radio frequency spectrum band (e.g., an amount of time the Wi-Fi UE may wait before the Wi-Fi UE intends to access the channel). Additionally, or alternatively, the inter-UE coordination message may indicate a duration and a start time (e.g., associated with the duration) during which the Wi-Fi UE may refrain from accessing the channel. For example, the inter-UE coordination message may indicate a duration and a start time during which the Wi-Fi UE may avoid transmitting using the shared radio frequency spectrum band. In some examples, the inter-UE coordination message may indicate time domain or frequency domain assistance information, for example transmitted as an NAV message (e.g., an equivalent NAV message) using Wi-Fi. In such examples, a MAC layer frame header (e.g., included in or associated with the NAV message) may include a duration field that may indicate a duration (e.g., transmission time) during which the shared radio frequency spectrum band may be used at (or otherwise occupied by) one or more cellular UEs as sensed by the intermediary UE that may be providing the assistance information. Additionally, or alternatively, in some examples, the inter-UE coordination message may indicate one or more communication channels of the shared radio frequency spectrum band (e.g., Wi-Fi channels, one or more frequency domain resources) that the Wi-Fi device may use or may refrain from using for transmitting using the shared radio frequency spectrum band. For example, the inter-UE coordination message may indicate one or more communication channels of the shared radio frequency spectrum band that the Wi-Fi device may avoid using for transmitting Wi-Fi messages.

In some examples, the inter-UE coordination message may include one or more time domain parameters that may be indicated (or otherwise provided) to the Wi-Fi UE using a quantity of interframe spaces. The time domain parameters (or time related parameters) may include one or more durations. For example, the intermediary UE may indicate a duration during which the Wi-Fi UE may avoid transmitting using the shared radio frequency spectrum band using short interframe space (SIFS), PCF interframe space (PISF), DCF interframe space (DCF), or extended interframe space (EIFS), among other examples. In some examples, the inter-UE coordination message may indicate a duration of z interframe spaces. In such an example, z interframe spaces may indicate, to the Wi-Fi UE, to avoid transmitting using the shared radio frequency spectrum band (e.g., to wait) for z interframe spaces, such as z SIFS. In some examples, z interframe spaces may indicate, to the Wi-Fi UE, to avoid transmitting using the shared radio frequency spectrum band for z interframe spaces prior to starting (e.g., beginning) a back off procedure. In some examples, the back off procedure may include transmitting an RTS, a CTS, or a NAV to indicate medium reservations. Additionally, or alternatively, z interframe spaces may indicate, to the Wi-Fi UE, to start the back off procedure (e.g., to access the channel) within z interframe spaces, such as z DIFS. For example, z interframe spaces may indicate, to the Wi-Fi UE, to start the back off procedure within z interframe spaces of the Wi-Fi UE performing the back off procedure (or performing some other scheduled Wi-Fi transmission).

As illustrated in the example of FIG. 3, the intermediary UE (e.g., the cellular and Wi-Fi UE, a cellular and Wi-Fi enabled device) may be provided with a transmission gap 310 during which the intermediary UE may transmit the inter-UE coordination message. For example, the intermediary UE may be configured with the transmission gap 310 during which the intermediary UE may transmit assistance information as a Wi-Fi message or a cellular message. Additionally, or alternatively, the intermediary UE may be configured with (or may otherwise identify) one or more resource sensing durations 305 during which the intermediary UE may collect sensing information. For example, the intermediary UE may collect sensing information during a sensing window, such as a default sensing window. For example, the intermediary UE may perform a resource sensing procedure during a resource sensing duration 305-a and a resource sensing duration 305-b. In some examples, the intermediary UE may transmit the assistance information (e.g., the inter-UE coordination message) during one or more time intervals (e.g., configured or preconfigured time intervals). For example, the intermediary UE may transmit the inter-UE coordination message during a transmission duration 315. In some examples, the time intervals may occur (e.g., be configured or preconfigured at the intermediary UE) periodically or aperiodically. That is, the intermediary may be configured with one or more periodic or aperiodic transmission duration (e.g., including the transmission duration 315) during which the intermediary UE may transmit the inter-UE coordination message.

In some examples, the intermediary UE may transmit assistance information (e.g., the inter-UE coordination message) based on an event-trigger. For example, the intermediary UE may transmit the inter-UE coordination message based on a reservation resource occupancy satisfying a threshold (e.g., exceeding a threshold). Additionally, or alternatively, the intermediary UE may transmit assistance information, such as using the inter-UE coordination message, based on a quantity of devices (e.g., cellular UEs or Wi-Fi UEs) in a geographic location associated with the intermediary UE (or another UE to which the inter-UE coordination message may be transmitted). For example, the intermediary UE may transmit the inter-UE coordination message based on the quantity of devices satisfying a threshold (e.g., exceeding a threshold). In some examples, the intermediary UE may determine whether the quantity of devices satisfies the threshold based on a quantity of identifiers, such as service set identifiers (SSIDs), detected at the intermediary UE. That is, the intermediary UE may use a quantity of SSIDs (or one or more other types of identifiers associated with one or more types of devices) as a metric for transmitting the inter-UE coordination message (e.g., assistance information using the inter-UE coordination message).

In some examples, the intermediary UE may transmit the inter-UE coordination message based on a request (e.g., an assistance request message) from one or more other devices (e.g., a cellular UE or a Wi-Fi UE). For example, in response to receiving an assistance request message from a Wi-Fi UE, the intermediary UE may transmit an inter-UE coordination message including (or indicating) assistance information. In such an example, the inter-UE coordination message may be based on a resource reservation map (e.g., a current resource map) that may be obtained at the intermediary UE. In some examples, the resource reservation map may be based on SCI transmitted from other UEs (e.g., cellular UEs) and decoded at the intermediary UE. Additionally, or alternatively, in response to receiving an assistance request message from a Wi-Fi UE, the intermediary UE may perform a resource sensing procedure. In some examples, the assistance request may indicate one or more duration (e.g., one or more future time period) associated with the assistance request. In such an example, the intermediary UE may perform the resource sensing procedure for the indicated durations and may transmit the inter-UE coordination message.

In some examples, the intermediary UE may support joint sensing operations. For example, multiple intermediary UEs (e.g., multiple cellular and Wi-Fi enabled devices) may transmit (e.g., jointly transmit, such a concurrently or in some order) inter-UE coordination messages that may incorporate information associated with cellular resources and information associated with Wi-Fi transmissions. In such an example, the inter-UE coordination message (e.g., the joint assistance message) may enable informed resource reservations performed by a receiving UE. The receiving UE may be an example of a cellular enabled device (e.g., a cellular UE) or a Wi-Fi enabled device (e.g., a Wi-Fi UE). For example, a Wi-Fi UE may obtain information regarding resources of the shared radio frequency spectrum that may be reserved for cellular communications, which may lead to reduced collision resource conflicts at the Wi-Fi UE and increased resource utilization, among other possible benefits.

In such an example, some intermediary UEs may operate as cellular UEs and perform sidelink operations, such that the intermediary UEs may provide cellular inter-UE coordination messages (e.g., default cellular inter-UE coordination messages). Additionally, or alternatively, some other intermediary UEs may operate as Wi-Fi UEs and perform Wi-Fi sensing operations. In such an example, the other intermediary UEs may report information obtained at the other intermediary UEs (e.g., based on the Wi-Fi sensing operations) as a cellular sidelink inter-UE resource reservation message. For example, a first intermediary UE may operate as a cellular UE and transmit an inter-UE coordination message as a cellular message (e.g., a default assistance message, a default coordination message) to a cellular UE (e.g., a UE that may be capable of supporting a cellular RAT and incapable of supporting a Wi-Fi RAT). In such an example, a second intermediary UE may operate as a Wi-Fi UE and transmit a Wi-Fi channel reservation message as a cellular message (e.g., an equivalent cellular assistance information message) to the cellular UE. In some examples, the second intermediary UE may transmit the Wi-Fi channel reservation message to the cellular UE using an inter-UE coordination message.

In some examples, an intermediary UE may determine whether to operate as a cellular UE or a Wi-Fi UE based on one or more identifiers, such as a transmission identifier, a destination identifier, or a provider service identifier (PSID), or any combination thereof. In some examples, the one or more identifiers may be identifiers used for a session associated with transmission of the inter-UE coordination message (e.g., a previous session, a current session, or a future session). Additionally, or alternatively, the intermediary UE may determine whether to operate as a cellular UE or a Wi-Fi UE based on a ratio (e.g., a configured ratio, a preconfigured ratio) between a first quantity of time during which the intermediary is to operate as a cellular UE and a second quantity of time during which the intermediary UE is to operate as a Wi-Fi UE. For example, the intermediary UE may determine whether to operate as a cellular UE or a Wi-Fi UE based on a ratio between a first duration during which the intermediary is to operate as a cellular UE and a second duration during which the intermediary UE is to operate as a Wi-Fi UE.

Additionally or alternatively, in some examples, the intermediary UE may autonomously determine whether to operate as a cellular UE or a Wi-Fi UE. For example, the intermediary UE may autonomously determine whether to operate as a cellular UE or a Wi-Fi UE based on determining that the ratio (e.g., the configured or preconfigured ratio) satisfies the threshold. In some examples, the intermediary UE may autonomously determine whether to operate as a cellular UE or a Wi-Fi UE based on determining that the ratio satisfies the threshold over a duration (e.g., a time window, a prespecified time window). For example, the intermediary UE may determine to operate as a cellular UE during a first duration (e.g., at time t) based on determining that the intermediary UE performed Wi-Fi operations (e.g., operated as a Wi-Fi UE) during a second duration (e.g., at time (t−1)).

Additionally, or alternatively, the intermediary UE may determine to operate as a Wi-Fi UE and may observe a channel environment based on one or more CTS messages or one or more NAV messages (or both). For example, the intermediary UE may observe a quality of a channel of the shared radio frequency spectrum band or a type or quantity of traffic associated with a channel of the shared radio frequency spectrum band based on one or more CTS messages or one or more NAV messages. In such examples, the intermediary UE operating as a Wi-Fi UE may identify a channel reservation duration and transmit a cellular inter-UE coordination message (e.g., an equivalent cellular sidelink inter-UE coordination message) indicating information associated with the Wi-Fi channel reservation. For example, the intermediary UE operating as a Wi-Fi UE may infer (e.g., based on observing the channel environment) a duration associated with a Wi-Fi reservation, such as reservation duration for Wi-Fi communications, and transmit the cellular inter-UE coordination message indicating information associated with the Wi-Fi channel reservation. In some examples of transmitting the cellular inter-UE coordination message, the intermediary UE may perform random transmission. For example, the UE may refrain from performing a resource sensing procedure or a partial resource sensing procedure, such as one or more cellular resource sensing procedures on the cellular sidelink. In some examples, performing random transmissions (e.g., refraining from performing a resource sensing procedure) may lead to increased accuracy associated with the Wi-Fi channel reservation information (e.g., may avoid the Wi-Fi channel reservation information becoming stale), among other possible benefits.

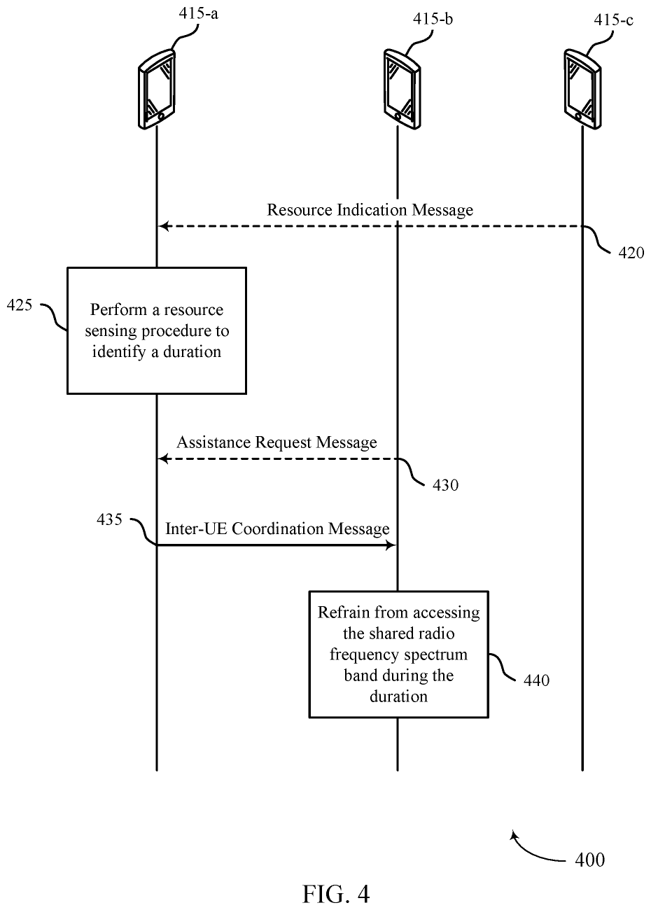

FIG. 4 illustrates an example of a process flow 400 that supports inter device coordination for unlicensed operation in accordance with one or more aspects of the present disclosure. The process flow 400 may implement or be implemented at or using one or more aspects of the wireless communications system 100, the wireless communications system 200, and the timing diagram 300. For example, the process flow 400 may be implemented at a UE 415-a, a UE 415-b, and a UE 415-c, which may be examples of a UE as described with reference to FIGS. 1-3. In some examples, the UEs 415 may implement the process flow 400 to promote network efficiencies by supporting a framework for coordination between devices capable of supporting multiple RATs. The process flow 400 may also be implemented by the UEs 415 to promote high reliability and low latency operations, among other benefits. In the following description of the process flow 400, the operations between the UEs 415 and the may occur in a different order than the example order shown, or the operations performed by the UEs 415 may be performed in different orders or at different times. Some operations may also be omitted.

At 425, the UE 415-a may perform a resource sensing procedure to identify a set of resources of a shared radio frequency spectrum band that may be reserved for wireless communications associated with a first RAT. In some examples, the UE 415-a may be an example of an intermediary UE as described throughout the present disclosure, including with reference to FIG. 3. For example, the UE 415-a may be capable of supporting a first RAT and a second RAT.

In some examples, the set of resources may be identified at the UE 415-a based on a resource indication message transmitted from the UE 415-c. For example, at 420, the UE 415-a may receive the resource indication message indicating at least one resource that may be reserved for wireless communications associated with the first RAT. In some examples, the resource indication message may include SCI or some other type of information associated with resource reservations for cellular communications. Additionally, or alternatively, the resource indication message may include a NAV message or some other type of information to indicate medium reservations for Wi-Fi communications. That is, the first RAT may correspond to one of a cellular RAT or Wi-Fi and the UE 415-c may be an example of a cellular UE or a Wi-Fi UE as described throughout the present disclosure, including with reference to FIGS. 2 and 3.

At 435, the UE 415-a may transmit an inter-UE coordination message to the UE 415-b. The UE 415-b may be an example of a cellular UE or a Wi-Fi UE as described throughout the present disclosure, including with reference to FIGS. 2 and 3. For example, the UE 415-b may be capable of supporting the second RAT, which may correspond to the other of the cellular RAT or Wi-Fi. The inter-UE coordination message may be an example of an inter-UE coordination message as described throughout the present disclosure, including with reference to FIGS. 2 and 3. For example, the inter-UE coordination message may be based on the resource sensing procedure performed at 425. Additionally, or alternatively, the inter-UE coordination message may indicate a duration during which the UE 415-b may avoid transmitting using the shared radio frequency spectrum band. The duration may be based on the identified set of resources.

In some examples, the UE 415-a may transmit the inter-UE coordination message indicating the duration in response to receiving an assistance request message from the UE 415-b. For example, at 430, the UE 415-a may receive the assistance request message from the UE 415-a. In some examples, the assistance request message may be an example of an assistance request message as described throughout the present disclosure, including with reference to FIG. 3. For example, the assistance request message may indicate a request for assistance information from the UE 415-a.

At 440, in response to receiving the inter-UE coordination message at 435, the UE 415-b may refrain from transmitting using resources of the shared radio frequency spectrum band during the duration. In some examples, refraining from transmitting during the duration may enable the UE 415-b to reduced collision resource conflicts between the UE 415-c and the UE 415-b and increased resource utilization, among other possible benefits.

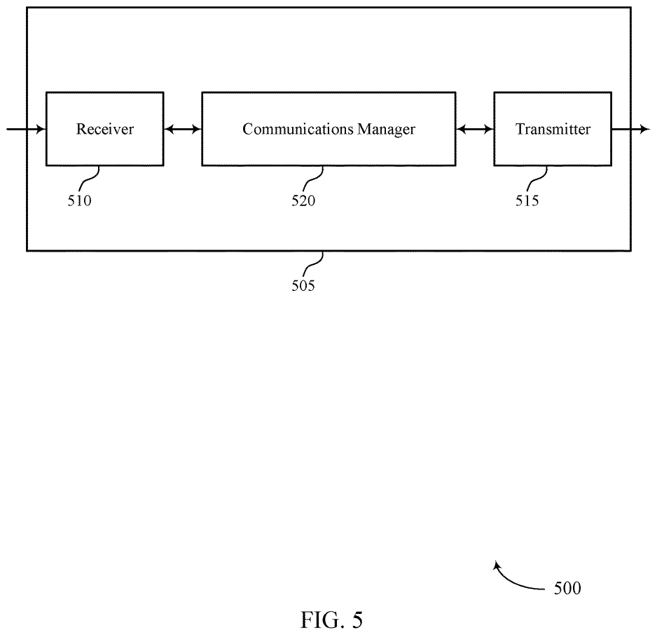

FIG. 5 shows a block diagram 500 of a device 505 that supports inter device coordination for unlicensed operation in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to inter device coordination for unlicensed operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to inter device coordination for unlicensed operation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of inter device coordination for unlicensed operation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first UE (e.g., the device 505) in accordance with examples as disclosed herein. For example, the communications manager 520 may be configured as or otherwise support a means for performing, at the first UE, a resource sensing procedure to identify a set of resources of a shared radio frequency spectrum band that is reserved for wireless communications associated with a first RAT, the first UE capable of supporting both the first RAT and a second RAT. The communications manager 520 may be configured as or otherwise support a means for transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

Additionally, or alternatively, the communications manager 520 may support wireless communication at a first UE (e.g., the device 505) in accordance with examples as disclosed herein. For example, the communications manager 520 may be configured as or otherwise support a means for receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT. The communications manager 520 may be configured as or otherwise support a means for refraining from transmitting using resources of the shared radio frequency spectrum band during the duration in response to receiving the inter-UE coordination message.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

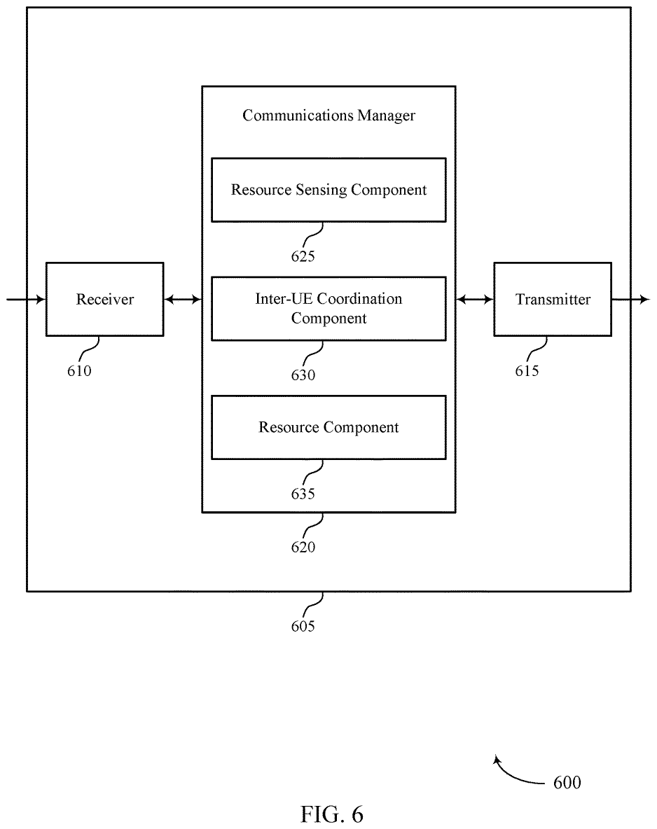

FIG. 6 shows a block diagram 600 of a device 605 that supports inter device coordination for unlicensed operation in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to inter device coordination for unlicensed operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inter device coordination for unlicensed operation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of inter device coordination for unlicensed operation as described herein. For example, the communications manager 620 may include a resource sensing component 625, an inter-UE coordination component 630, a resource component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE (e.g., device 605) in accordance with examples as disclosed herein. The resource sensing component 625 may be configured as or otherwise support a means for performing, at the first UE, a resource sensing procedure to identify a set of resources of a shared radio frequency spectrum band that is reserved for wireless communications associated with a first RAT, the first UE capable of supporting both the first RAT and a second RAT. The inter-UE coordination component 630 may be configured as or otherwise support a means for transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

Additionally, or alternatively, the communications manager 620 may support wireless communication at a first UE (e.g., the device 605) in accordance with examples as disclosed herein. The inter-UE coordination component 630 may be configured as or otherwise support a means for receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT. The resource component 635 may be configured as or otherwise support a means for refraining from transmitting using resources of the shared radio frequency spectrum band during the duration in response to receiving the inter-UE coordination message.

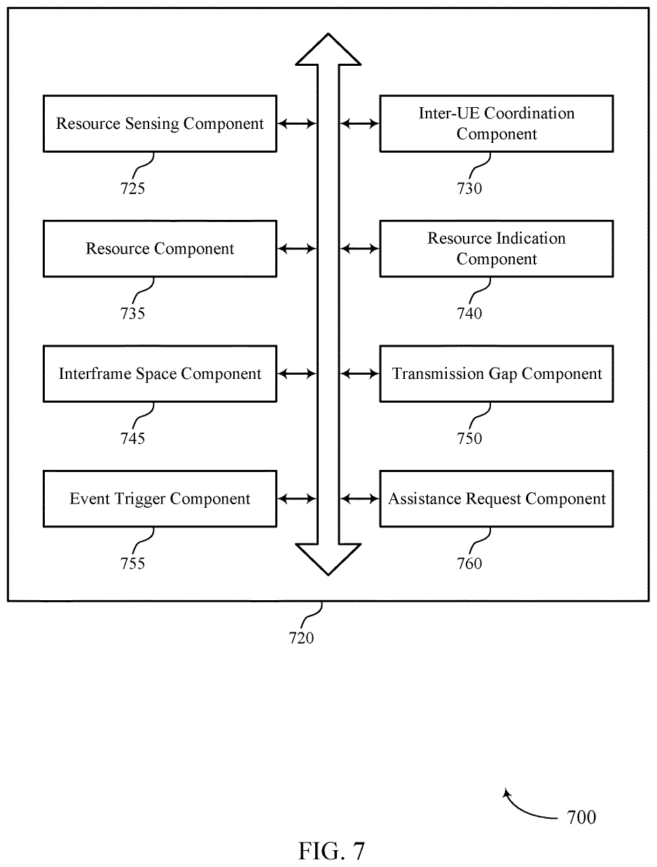

FIG. 7 shows a block diagram 700 of a communications manager 720 that supports inter device coordination for unlicensed operation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of inter device coordination for unlicensed operation as described herein. For example, the communications manager 720 may include a resource sensing component 725, an inter-UE coordination component 730, a resource component 735, a resource indication component 740, an interframe space component 745, a transmission gap component 750, an event trigger component 755, an assistance request component 760, or any combination thereof. Each of these components may communicate, directly or indirectly, with one another (e.g., via one or more buses).

The communications manager 720 may support wireless communication at a first UE in accordance with examples as disclosed herein. The resource sensing component 725 may be configured as or otherwise support a means for performing, at the first UE, a resource sensing procedure to identify a set of resources of a shared radio frequency spectrum band that is reserved for wireless communications associated with a first RAT, the first UE capable of supporting both the first RAT and a second RAT. The inter-UE coordination component 730 may be configured as or otherwise support a means for transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

In some examples, the resource indication component 740 may be configured as or otherwise support a means for receiving, from a third UE capable of supporting the first RAT, a message indicating at least one resource that is reserved for wireless communications associated with the first RAT, where the set of resources is identified based on the message.

In some examples, to support transmitting the inter-UE coordination message, the inter-UE coordination component 730 may be configured as or otherwise support a means for transmitting, to the second UE, the inter-UE coordination message indicating the duration and a start time associated with the duration.

In some examples, to support transmitting the inter-UE coordination message, the interframe space component 745 may be configured as or otherwise support a means for transmitting, to the second UE, the inter-UE coordination message indicating a quantity of interframe spaces during which the second UE is to avoid transmitting using the shared radio frequency spectrum band.

In some examples, to support transmitting the inter-UE coordination message, the inter-UE coordination component 730 may be configured as or otherwise support a means for transmitting, to the second UE, the inter-UE coordination message including a duration field that indicates a transmission duration during which a communication channel of the shared radio frequency spectrum band is occupied, the transmission duration including the duration.

In some examples, to support transmitting the inter-UE coordination message, the inter-UE coordination component 730 may be configured as or otherwise support a means for transmitting, to the second UE, the inter-UE coordination message indicating the duration and a communication channel of the shared radio frequency spectrum band that the second UE is to use or is to avoid transmitting using for wireless communications associated with the second RAT.

In some examples, to support transmitting the inter-UE coordination message, the transmission gap component 750 may be configured as or otherwise support a means for transmitting, to the second UE, the inter-UE coordination message indicating the duration during a transmission gap. In some examples, the transmission gap corresponds to a time interval of a set of multiple time intervals that occur periodically or aperiodically.

In some examples, to support transmitting the inter-UE coordination message, the event trigger component 755 may be configured as or otherwise support a means for transmitting, to the second UE, the inter-UE coordination message indicating the duration in response to identifying that an event trigger is satisfied.

In some examples, to support transmitting the inter-UE coordination message, the inter-UE coordination component 730 may be configured as or otherwise support a means for transmitting, to the second UE, the inter-UE coordination message indicating the duration in response to a quantity of UEs located in an environment associated with the first UE satisfying a threshold.

In some examples, to support transmitting the inter-UE coordination message, the assistance request component 760 may be configured as or otherwise support a means for receiving, from the second UE, a message indicating a request for assistance information from the first UE. In some examples, to support transmitting the inter-UE coordination message, the inter-UE coordination component 730 may be configured as or otherwise support a means for transmitting, to the second UE, the inter-UE coordination message indicating the duration in response to receiving the request.

In some examples, to support receiving the request, the assistance request component 760 may be configured as or otherwise support a means for receiving, from the second UE, the message indicating the request for assistance information corresponding to a second duration, where the resource sensing procedure is performed in response to the indicated request, and where the set of resources occur during the second duration.

In some examples, to support performing the resource sensing procedure, the resource sensing component 725 may be configured as or otherwise support a means for performing, at the first UE, the resource sensing procedure to identify the set of resources of the shared radio frequency spectrum band that is reserved for wireless communications associated with the first RAT, where the first RAT is based on one or more of an identifier associated with the first UE, an identifier associated with the second UE, and an identifier associated with a service provider for the first UE.

In some examples, to support performing the resource sensing procedure, the resource sensing component 725 may be configured as or otherwise support a means for performing, at the first UE, the resource sensing procedure to identify the set of resources of the shared radio frequency spectrum band that is reserved for wireless communications associated with the first RAT, where the first RAT is based on a ratio between a first duration during which the first UE is to perform a first type of wireless communications and a second duration during which the first UE is to perform a second type of wireless communications. In some examples, the first RAT is based on the ratio between the first duration and the second duration being satisfied during a time window.

In some examples, to support performing the resource sensing procedure, the resource sensing component 725 may be configured as or otherwise support a means for performing, at the first UE during a first duration, the resource sensing procedure to identify the set of resources of the shared radio frequency spectrum band that is reserved for wireless communications associated with the first RAT, where the first RAT corresponds to a first type of wireless communications based on the first UE performing a second type of wireless communications during a second duration prior to the first duration.

In some examples, to support performing the resource sensing procedure, the resource sensing component 725 may be configured as or otherwise support a means for performing, at the first UE, the resource sensing procedure to identify a first set of resources of the shared radio frequency spectrum band that is reserved for wireless communications associated with the first RAT. In some examples, to support performing the resource sensing procedure, the resource sensing component 725 may be configured as or otherwise support a means for performing, at the first UE, a partial resource sensing procedure to identify a second set of resources of the shared radio frequency spectrum band that is reserved for wireless communications associated with the second RAT, where the duration is based on the identified first set of resources and the identified second set of resources.

Additionally, or alternatively, the communications manager 720 may support wireless communication at a first UE in accordance with examples as disclosed herein. In some examples, the inter-UE coordination component 730 may be configured as or otherwise support a means for receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT. The resource component 735 may be configured as or otherwise support a means for refraining from transmitting using resources of the shared radio frequency spectrum band during the duration in response to receiving the inter-UE coordination message.

In some examples, to support receiving the inter-UE coordination message, the inter-UE coordination component 730 may be configured as or otherwise support a means for receiving, from the second UE, the inter-UE coordination message indicating the duration that is based on the set of resources, where the set of resources is identified at the second UE based on a resource sensing procedure performed at the second UE.

In some examples, the duration is based on a second set of resources that is reserved for wireless communications associated with the second RAT. In some examples, the second set of resources is identified at the second UE based on a partial sensing procedure performed at the second UE. In some examples, to support receiving the inter-UE coordination message, the inter-UE coordination component 730 may be configured as or otherwise support a means for receiving, from the second UE, the inter-UE coordination message indicating the duration and a start time associated with the duration.

In some examples, to support receiving the inter-UE coordination message, the interframe space component 745 may be configured as or otherwise support a means for receiving, from the second UE, the inter-UE coordination message indicating a quantity of interframe spaces during which the first UE is to avoid transmitting using the shared radio frequency spectrum band.

In some examples, to support receiving the inter-UE coordination message, the inter-UE coordination component 730 may be configured as or otherwise support a means for receiving, from the second UE, the inter-UE coordination message including a duration field that indicates a transmission duration during which a communication channel of the shared radio frequency spectrum band is occupied, the transmission duration including the duration.

In some examples, to support receiving the inter-UE coordination message, the inter-UE coordination component 730 may be configured as or otherwise support a means for receiving, from the second UE, the inter-UE coordination message indicating the duration and a communication channel of the shared radio frequency spectrum band that the first UE is to use or is to avoid transmitting using for wireless communications associated with the second RAT.

In some examples, to support receiving the inter-UE coordination message, the transmission gap component 750 may be configured as or otherwise support a means for receiving, from the second UE, the inter-UE coordination message indicating the duration during a transmission gap.

In some examples, to support receiving the inter-UE coordination message, the event trigger component 755 may be configured as or otherwise support a means for receiving, from the second UE, the inter-UE coordination message indicating the duration based on an event trigger being satisfied or a quantity of UEs located in an environment associated with the second UE satisfying a threshold.

In some examples, to support receiving the inter-UE coordination message, the assistance request component 760 may be configured as or otherwise support a means for transmitting, to the second UE, a message indicating a request for assistance information from the second UE. In some examples, to support receiving the inter-UE coordination message, the inter-UE coordination component 730 may be configured as or otherwise support a means for receiving, from the second UE, the inter-UE coordination message indicating the duration in response to transmitting the request.

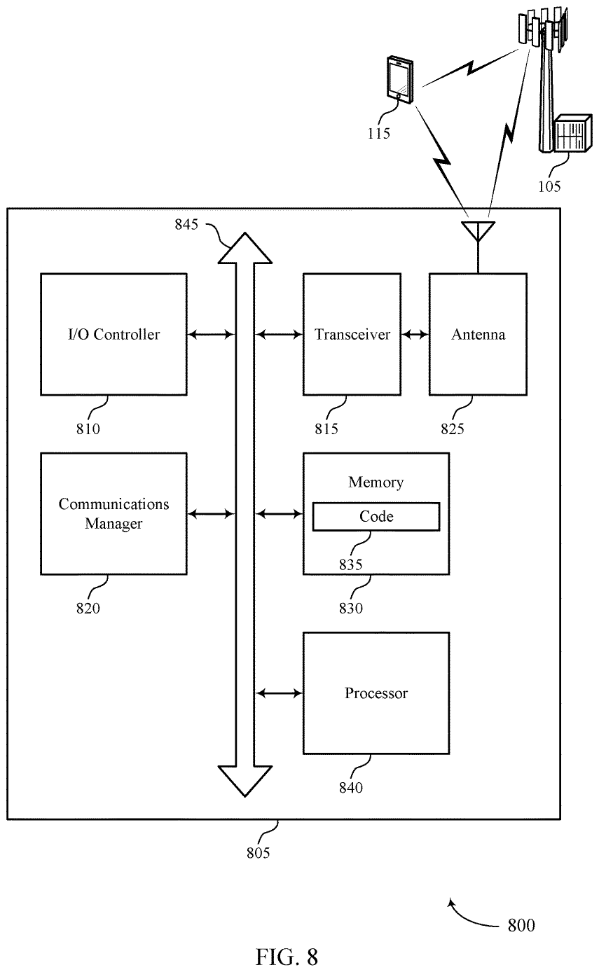

FIG. 8 shows a diagram of a system 800 including a device 805 that supports inter device coordination for unlicensed operation in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting inter device coordination for unlicensed operation). For example, the device 805 or a component of the device 805 may include a processor 840 and memory 830 coupled with or to the processor 840, the processor 840 and memory 830 configured to perform various functions described herein.

The communications manager 820 may support wireless communication at a first UE (e.g., the device 805) in accordance with examples as disclosed herein. For example, the communications manager 820 may be configured as or otherwise support a means for performing, at the first UE, a resource sensing procedure to identify a set of resources of a shared radio frequency spectrum band that is reserved for wireless communications associated with a first RAT, the first UE capable of supporting both the first RAT and a second RAT. The communications manager 820 may be configured as or otherwise support a means for transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources.

Additionally, or alternatively, the communications manager 820 may support wireless communication at a first UE (e.g., the device 805) in accordance with examples as disclosed herein. For example, the communications manager 820 may be configured as or otherwise support a means for receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT. The communications manager 820 may be configured as or otherwise support a means for refraining from transmitting using resources of the shared radio frequency spectrum band during the duration in response to receiving the inter-UE coordination message.

By including or configuring the communications manager 820 in accordance with examples as described herein, the device 805 may support techniques for more efficient utilization of communication resources and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of inter device coordination for unlicensed operation as described herein, or the processor 840 and the memory 830 may be otherwise configured to perform or support such operations.

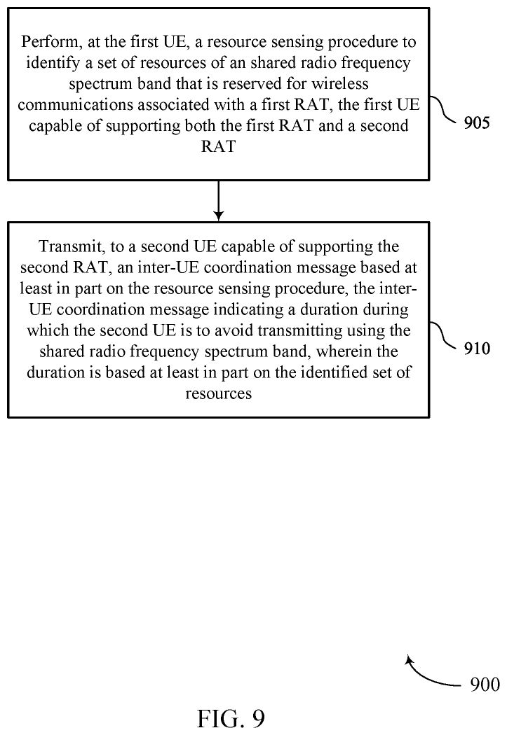

FIG. 9 shows a flowchart illustrating a method 900 that supports inter device coordination for unlicensed operation in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include performing, at the first UE, a resource sensing procedure to identify a set of resources of a shared radio frequency spectrum band that is reserved for wireless communications associated with a first RAT, the first UE capable of supporting both the first RAT and a second RAT. The operations of 905 may be performed in accordance with examples as disclosed herein. In some examples, aspects of the operations of 905 may be performed by a resource sensing component 725 as described with reference to FIG. 7.

At 910, the method may include transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources. The operations of 910 may be performed in accordance with examples as disclosed herein. In some examples, aspects of the operations of 910 may be performed by an inter-UE coordination component 730 as described with reference to FIG. 7.

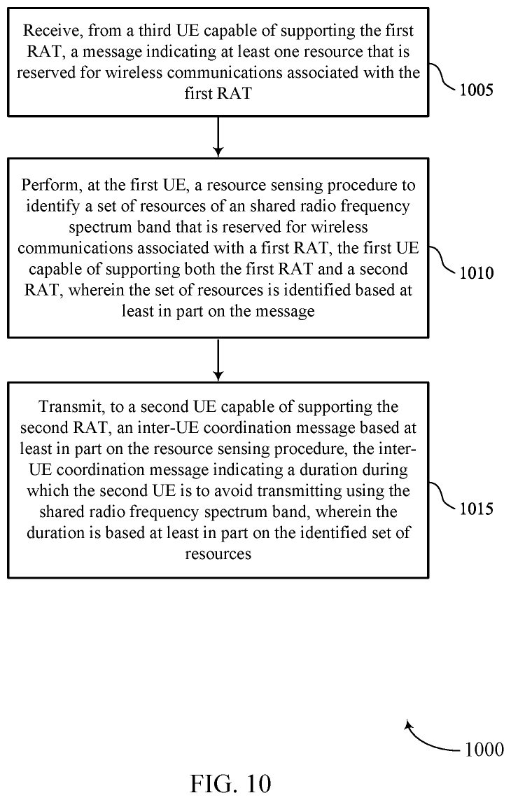

FIG. 10 shows a flowchart illustrating a method 1000 that supports inter device coordination for unlicensed operation in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a third UE capable of supporting the first RAT, a message indicating at least one resource that is reserved for wireless communications associated with the first RAT. The operations of 1005 may be performed in accordance with examples as disclosed herein. In some examples, aspects of the operations of 1005 may be performed by a resource indication component 740 as described with reference to FIG. 7.

At 1010, the method may include performing, at the first UE, a resource sensing procedure to identify a set of resources of a shared radio frequency spectrum band that is reserved for wireless communications associated with a first RAT, the first UE capable of supporting both the first RAT and a second RAT, where the set of resources is identified based on the message. The operations of 1010 may be performed in accordance with examples as disclosed herein. In some examples, aspects of the operations of 1010 may be performed by a resource sensing component 725 as described with reference to FIG. 7.

At 1015, the method may include transmitting, to a second UE capable of supporting the second RAT, an inter-UE coordination message based on the resource sensing procedure, the inter-UE coordination message indicating a duration during which the second UE is to avoid transmitting using the shared radio frequency spectrum band, where the duration is based on the identified set of resources. The operations of 1015 may be performed in accordance with examples as disclosed herein. In some examples, aspects of the operations of 1015 may be performed by an inter-UE coordination component 730 as described with reference to FIG. 7.

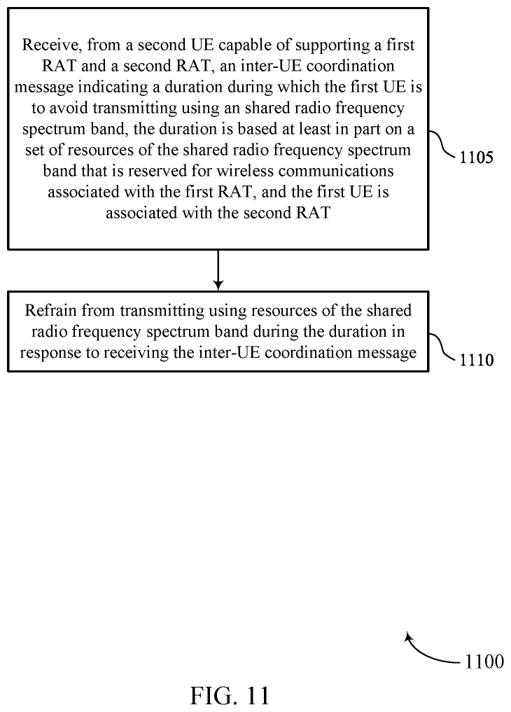

FIG. 11 shows a flowchart illustrating a method 1100 that supports inter device coordination for unlicensed operation in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT. The operations of 1105 may be performed in accordance with examples as disclosed herein. In some examples, aspects of the operations of 1105 may be performed by an inter-UE coordination component 730 as described with reference to FIG. 7.

At 1110, the method may include refraining from transmitting using resources of the shared radio frequency spectrum band during the duration in response to receiving the inter-UE coordination message. The operations of 1110 may be performed in accordance with examples as disclosed herein. In some examples, aspects of the operations of 1110 may be performed by a resource component 735 as described with reference to FIG. 7.

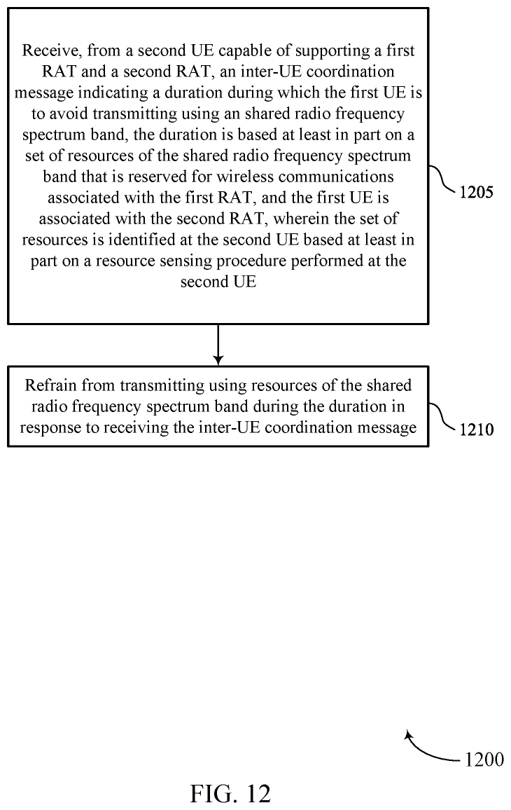

FIG. 12 shows a flowchart illustrating a method 1200 that supports inter device coordination for unlicensed operation in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include receiving, from a second UE capable of supporting a first RAT and a second RAT, an inter-UE coordination message indicating a duration during which the first UE is to avoid transmitting using a shared radio frequency spectrum band, the duration is based on a set of resources of the shared radio frequency spectrum band that is reserved for wireless communications associated with the first RAT, and the first UE is associated with the second RAT, where the set of resources is identified at the second UE based on a resource sensing procedure performed at the second UE. The operations of 1205 may be performed in accordance with examples as disclosed herein. In some examples, aspects of the operations of 1205 may be performed by an inter-UE coordination component 730 as described with reference to FIG. 7.

At 1210, the method may include refraining from transmitting using resources of the shared radio frequency spectrum band during the duration in response to receiving the inter-UE coordination message. The operations of 1210 may be performed in accordance with examples as disclosed herein. In some examples, aspects of the operations of 1210 may be performed by a resource component 735 as described with reference to FIG. 7.

The following provides an overview of aspects of the present disclosure:

Aspect 1: A method for wireless communication at a first UE, comprising: performing, at the first UE, a resource sensing procedure to identify a set of resources of a shared radio frequency spectrum band that is reserved for wireless communications associated with a first RAT, the first UE capable of supporting both the first RAT and a second RAT; and transmitting, to a second UE capable of supporting the second RAT, an inter-UE coordination message based at least in part on the resource sensing procedure, the inter-UE coordination message indicating a duration during which the second UE is to avoid transmitting using the shared radio frequency spectrum band, wherein the duration is based at least in part on the identified set of resources.

Aspect 2: The method of aspect 1, further comprising: receiving, from a third UE capable of supporting the first RAT, a message indicating at least one resource that is reserved for wireless communications associated with the first RAT, wherein the set of resources is identified based at least in part on the message.

Aspect 3: The method of any of aspects 1 through 2, wherein transmitting the inter-UE coordination message comprises: transmitting, to the second UE, the inter-UE coordination message indicating the duration and a start time associated with the duration.

Aspect 4: The method of any of aspects 1 through 2, wherein transmitting the inter-UE coordination message comprises: transmitting, to the second UE, the inter-UE coordination message indicating a quantity of interframe spaces during which the second UE is to avoid transmitting using the shared radio frequency spectrum band.

Aspect 5: The method of any of aspects 1 through 4, wherein transmitting the inter-UE coordination message comprises: transmitting, to the second UE, the inter-UE coordination message including a duration field that indicates a transmission duration during which a communication channel of the shared radio frequency spectrum band is occupied, the transmission duration comprising the duration.

Aspect 6: The method of any of aspects 1 through 5, wherein transmitting the inter-UE coordination message comprises: transmitting, to the second UE, the inter-UE coordination message indicating the duration and a communication channel of the shared radio frequency spectrum band that the second UE is to use or is to avoid transmitting using for wireless communications associated with the second RAT.

Aspect 7: The method of any of aspects 1 through 6, wherein transmitting the inter-UE coordination message comprises: transmitting, to the second UE, the inter-UE coordination message indicating the duration during a transmission gap.

Aspect 8: The method of aspect 7, wherein the transmission gap corresponds to a time interval of a plurality of time intervals that occur periodically or aperiodically.

Aspect 9: The method of any of aspects 1 through 8, wherein transmitting the inter-UE coordination message comprises: transmitting, to the second UE, the inter-UE coordination message indicating the duration in response to identifying that an event trigger is satisfied.

Aspect 10: The method of any of aspects 1 through 8, wherein transmitting the inter-UE coordination message comprises: transmitting, to the second UE, the inter-UE coordination message indicating the duration in response to a quantity of UEs located in an environment associated with the first UE satisfying a threshold.

Aspect 11: The method of any of aspects 1 through 8, wherein transmitting the inter-UE coordination message comprises: receiving, from the second UE, a message indicating a request for assistance information from the first UE; and transmitting, to the second UE, the inter-UE coordination message indicating the duration in response to receiving the request.

Aspect 12: The method of aspect 11, wherein receiving the request comprises: receiving, from the second UE, the message indicating the request for assistance information corresponding to a second duration, wherein the resource sensing procedure is performed in response to the indicated request, and wherein the set of resources occur during the second duration.

Aspect 13: The method of any of aspects 1 through 12, wherein performing the resource sensing procedure comprises: performing, at the first UE, the resource sensing procedure to identify the set of resources of the shared radio frequency spectrum band that is reserved for wireless communications associated with the first RAT, wherein the first RAT is based at least in part on one or more of an identifier associated with the first UE, an identifier associated with the second UE, and an identifier associated with a service provider for the first UE.

Aspect 14: The method of any of aspects 1 through 12, wherein performing the resource sensing procedure comprises: performing, at the first UE, the resource sensing procedure to identify the set of resources of the shared radio frequency spectrum band that is reserved for wireless communications associated with the first RAT, wherein the first RAT is based at least in part on a ratio between a first duration during which the first UE is to perform a first type of wireless communications and a second duration during which the first UE is to perform a second type of wireless communications.

Aspect 15: The method of aspect 14, wherein the first RAT is based at least in part on the ratio between the first duration and the second duration being satisfied during a time window.

Aspect 16: The method of any of aspects 1 through 12, wherein performing the resource sensing procedure comprises: performing, at the first UE during a first duration, the resource sensing procedure to identify the set of resources of the shared radio frequency spectrum band that is reserved for wireless communications associated with the first RAT, wherein the first RAT corresponds to a first type of wireless communications based at least in part on the first UE performing a second type of wireless communications during a second duration prior to the first duration.

Aspect 17: The method of any of aspects 1 through 16, wherein performing the resource sensing procedure comprises: performing, at the first UE, the resource sensing procedure to identify a first set of resources of the shared radio frequency spectrum band that is reserved for wireless communications associated with the first RAT; and performing, at the first UE, a partial resource sensing procedure to identify a second set of resources of the shared radio frequency spectrum band that is reserved for wireless communications associated with the second RAT, wherein the duration is based at least in part on the identified first set of resources and the identified second set of resources.

Aspect 18: A method for wireless communication at a first UE, comprising: receiving, from a second UE capable of supporting a first RAT and a second RAT, an inter-UE coordination message indicating a duration during which the first UE is to avoid transmitting using a shared radio frequency spectrum band, the duration is based at least in part on a set of resources of the shared radio frequency spectrum band that is reserved for wireless communications associated with the first RAT, and the first UE is associated with the second RAT; and refraining from transmitting using resources of the shared radio frequency spectrum band during the duration in response to receiving the inter-UE coordination message.

Aspect 19: The method of aspect 18, wherein receiving the inter-UE coordination message comprises: receiving, from the second UE, the inter-UE coordination message indicating the duration that is based at least in part on the set of resources, wherein the set of resources is identified at the second UE based at least in part on a resource sensing procedure performed at the second UE.

Aspect 20: The method of aspect 19, wherein the duration is based at least in part on a second set of resources that is reserved for wireless communications associated with the second RAT, and the second set of resources is identified at the second UE based at least in part on a partial sensing procedure performed at the second UE

Aspect 21: The method of any of aspects 19 through 20, wherein receiving the inter-UE coordination message comprises: receiving, from the second UE, the inter-UE coordination message indicating the duration and a start time associated with the duration.

Aspect 22: The method of any of aspects 19 through 20, wherein receiving the inter-UE coordination message comprises: receiving, from the second UE, the inter-UE coordination message indicating a quantity of interframe spaces during which the first UE is to avoid transmitting using the shared radio frequency spectrum band.

Aspect 23: The method of any of aspects 18 through 22, wherein receiving the inter-UE coordination message comprises: receiving, from the second UE, the inter-UE coordination message including a duration field that indicates a transmission duration during which a communication channel of the shared radio frequency spectrum band is occupied, the transmission duration comprising the duration.

Aspect 24: The method of any of aspects 18 through 23, wherein receiving the inter-UE coordination message comprises: receiving, from the second UE, the inter-UE coordination message indicating the duration and a communication channel of the shared radio frequency spectrum band that the first UE is to use or is to avoid transmitting using for wireless communications associated with the second RAT.

Aspect 25: The method of any of aspects 18 through 24, wherein receiving the inter-UE coordination message comprises: receiving, from the second UE, the inter-UE coordination message indicating the duration during a transmission gap.

Aspect 26: The method of any of aspects 18 through 25, wherein receiving the inter-UE coordination message comprises: receiving, from the second UE, the inter-UE coordination message indicating the duration based at least in part on an event trigger being satisfied or a quantity of UEs located in an environment associated with the second UE satisfying a threshold.

Aspect 27: The method of any of aspects 18 through 25, wherein receiving the inter-UE coordination message comprises: transmitting, to the second UE, a message indicating a request for assistance information from the second UE; and receiving, from the second UE, the inter-UE coordination message indicating the duration in response to transmitting the request.

Aspect 28: An apparatus for wireless communication at a first UE, comprising a processor; memory coupled with the processor; and instructions stored in the memory and executable by the processor to cause the apparatus to perform a method of any of aspects 1 through 17.

Aspect 29: An apparatus for wireless communication at a first UE, comprising at least one means for performing a method of any of aspects 1 through 17.

Aspect 30: A non-transitory computer-readable medium storing code for wireless communication at a first UE, the code comprising instructions executable by a processor to perform a method of any of aspects 1 through 17.

Aspect 31: An apparatus for wireless communication at a first UE, comprising a processor; memory coupled with the processor; and instructions stored in the memory and executable by the processor to cause the apparatus to perform a method of any of aspects 18 through 27.

Aspect 32: An apparatus for wireless communication at a first UE, comprising at least one means for performing a method of any of aspects 18 through 27.

Aspect 33: A non-transitory computer-readable medium storing code for wireless communication at a first UE, the code comprising instructions executable by a processor to perform a method of any of aspects 18 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first user equipment (UE), comprising:
performing, at the first UE, a resource sensing procedure to identify a set of resources of a shared radio frequency spectrum band that is reserved for wireless communications associated with a first radio access technology, the first UE capable of supporting both the first radio access technology and a second radio access technology; and
transmitting, to a second UE capable of supporting the second radio access technology, an inter-UE coordination message based at least in part on the resource sensing procedure, the inter-UE coordination message indicating a duration during which the second UE is to avoid transmitting using the shared radio frequency spectrum band, wherein the duration is based at least in part on the identified set of resources.

2. The method of claim 1, further comprising:
receiving, from a third UE capable of supporting the first radio access technology, a message indicating at least one resource that is reserved for wireless communications associated with the first radio access technology, wherein the set of resources is identified based at least in part on the message.

3. (canceled)

4. The method of claim 1, wherein transmitting the inter-UE coordination message comprises:
transmitting, to the second UE, the inter-UE coordination message indicating a quantity of interframe spaces during which the second UE is to avoid transmitting using the shared radio frequency spectrum band.

5. The method of claim 1, wherein transmitting the inter-UE coordination message comprises:
transmitting, to the second UE, the inter-UE coordination message including a duration field that indicates a transmission duration during which a communication channel of the shared radio frequency spectrum band is occupied, the transmission duration comprising the duration.

6. (canceled)

7. The method of claim 1, wherein transmitting the inter-UE coordination message comprises:
transmitting, to the second UE, the inter-UE coordination message indicating the duration during a transmission gap.

8. The method of claim 7, wherein the transmission gap corresponds to a time interval of a plurality of time intervals that occur periodically or aperiodically.

9. The method of claim 1, wherein transmitting the inter-UE coordination message comprises:
transmitting, to the second UE, the inter-UE coordination message indicating the duration in response to identifying that an event trigger is satisfied.

10. The method of claim 1, wherein transmitting the inter-UE coordination message comprises:
transmitting, to the second UE, the inter-UE coordination message indicating the duration in response to a quantity of UEs located in an environment associated with the first UE satisfying a threshold.

11-12. (canceled)

13. The method of claim 1, wherein performing the resource sensing procedure comprises:
performing, at the first UE, the resource sensing procedure to identify the set of resources of the shared radio frequency spectrum band that is reserved for wireless communications associated with the first radio access technology, wherein the first radio access technology is based at least in part on one or more of an identifier associated with the first UE, an identifier associated with the second UE, and an identifier associated with a service provider for the first UE.

14. The method of claim 1, wherein performing the resource sensing procedure comprises:
performing, at the first UE, the resource sensing procedure to identify the set of resources of the shared radio frequency spectrum band that is reserved for wireless communications associated with the first radio access technology, wherein the first radio access technology is based at least in part on a ratio between a first duration during which the first UE is to perform a first type of wireless communications and a second duration during which the first UE is to perform a second type of wireless communications.

15. The method of claim 14, wherein the first radio access technology is based at least in part on the ratio between the first duration and the second duration being satisfied during a time window.

16. The method of claim 1, wherein performing the resource sensing procedure comprises:
performing, at the first UE during a first duration, the resource sensing procedure to identify the set of resources of the shared radio frequency spectrum band that is reserved for wireless communications associated with the first radio access technology, wherein the first radio access technology corresponds to a first type of wireless communications based at least in part on the first UE performing a second type of wireless communications during a second duration prior to the first duration.

17. The method of claim 1, wherein performing the resource sensing procedure comprises:
performing, at the first UE, the resource sensing procedure to identify a first set of resources of the shared radio frequency spectrum band that is reserved for wireless communications associated with the first radio access technology; and
performing, at the first UE, a partial resource sensing procedure to identify a second set of resources of the shared radio frequency spectrum band that is reserved for wireless communications associated with the second radio access technology, wherein the duration is based at least in part on the identified first set of resources and the identified second set of resources.

18. A method for wireless communication at a first user equipment (UE), comprising:
receiving, from a second UE capable of supporting a first radio access technology and a second radio access technology, an inter-UE coordination message indicating a duration during which the first UE is to avoid transmitting using a shared radio frequency spectrum band, the duration is based at least in part on a set of resources of the shared radio frequency spectrum band that is reserved for wireless communications associated with the first radio access technology, and the first UE is associated with the second radio access technology; and
refraining from transmitting using resources of the shared radio frequency spectrum band during the duration in response to receiving the inter-UE coordination message.

19. The method of claim 18, wherein receiving the inter-UE coordination message comprises:
receiving, from the second UE, the inter-UE coordination message indicating the duration that is based at least in part on the set of resources, wherein the set of resources is identified at the second UE based at least in part on a resource sensing procedure performed at the second UE.

20. The method of claim 19, wherein:
the duration is based at least in part on a second set of resources that is reserved for wireless communications associated with the second radio access technology, and
the second set of resources is identified at the second UE based at least in part on a partial sensing procedure performed at the second UE.

21. (canceled)

22. The method of claim 18, wherein receiving the inter-UE coordination message comprises:
receiving, from the second UE, the inter-UE coordination message indicating a quantity of interframe spaces during which the first UE is to avoid transmitting using the shared radio frequency spectrum band.

23-24. (canceled)

25. The method of claim 18, wherein receiving the inter-UE coordination message comprises:
receiving, from the second UE, the inter-UE coordination message indicating the duration during a transmission gap.

26-27. (canceled)

28. An apparatus for wireless communication at a first user equipment (UE), comprising:
a processor;
memory coupled with the processor; and
instructions stored in the memory and executable by the processor to cause the apparatus to:
perform, at the first UE, a resource sensing procedure to identify a set of resources of a shared radio frequency spectrum band that is reserved for wireless communications associated with a first radio access technology, the first UE capable of supporting both the first radio access technology and a second radio access technology; and
transmit, to a second UE capable of supporting the second radio access technology, an inter-UE coordination message based at least in part on the resource sensing procedure, the inter-UE coordination message indicating a duration during which the second UE is to avoid transmitting using the shared radio frequency spectrum band, wherein the duration is based at least in part on the identified set of resources.

29. The apparatus of claim 28, wherein the instructions are further executable by the processor to cause the apparatus to:
receive, from a third UE capable of supporting the first radio access technology, a message indicating at least one resource that is reserved for wireless communications associated with the first radio access technology, wherein the set of resources is identified based at least in part on the message.

30. (canceled)
